(19) United States
(12) Patent Application Publication
(10) Pub. No.: US 2004/0048522 A1
(43) Pub. Date: Mar. 11, 2004

(54) Fire-rated wire etc. connectors

(76) Inventors: Hugh David Facey, Sheffield (GB); Brian Edward Shawcross, Retford (GB); Derek Boaler, Sheffield (GB)

Correspondence Address: TREXLER, BUSHNELL, GIANGIORGI,, BLACKSTONE & MARR, LTD., 36TH FLOOR, 105 WEST ADAMS STREET, CHICAGO, IL, 60603, US

(21) Appl. No.: 10/241,110

(22) Filed: Sep. 11, 2002

(51) Int. Cl. H01R 11/01

(52) U.S. Cl. 439/783

(57) ABSTRACT

A fire-rated wire etc. connector (10) is of the type having within a metal body (11) twin bores (12) at least one of which is associated with wedge means (14) preventing withdrawal of a wire (20) or suspension strand in the opposite direction to insertion, and the wedge means (14) is made of ceramic material.

Wedge means (14) may be associated with both bores (12) and are preferably wedges with ribs (15) for engagement with wires (20) inserted in the bores, the wedges being guided within channels (16) which converge towards the inlet ends (17) of respective bores, with compression springs (18) between abutments (19) and the wedge means (14) to urge the latter towards an intervening thin wall (13) between the bores, and, although preferably made of stainless steel, the abutments (19) may be made of plastics because once the wedge means have become secured in gripping engagement with wires the abutments (19) and springs (18) are redundant.

This invention relates to connectors for wire or the like, e.g. cables or strands, hereinafter referred to simply as “wire”, and has for its object the provision of a fire-rated connector such as can be used in a method of suspending equipment as described in GB-A-2 322 435, in which the connector or locking device is of the type having within a metal body twin bores at least one of which is associated with wedging means preventing withdrawal of a wire or suspension strand in the opposite direction to insertion, it being usual for both bores to be so provided.

It is known from GB-A-2210517 to provide metal-bodied connectors in which wires can be located in twin bores in close lengthwise relationship and are urged towards the intervening thin wall by wedging means, e.g. balls (or rollers) guided within channels which converge towards the inlet ends of respective bores, with compression springs between abutments and the balls (or rollers) to urge the latter towards the intervening wall for gripping engagement with inserted wires.

It is also known from GB-A-2240581 to provide ribs on rollers in a connector as in GBA-2210517 to enhance the grip of the rollers, and from WO-A-9530844 to provide ribbed wedges in a connector as in GB-A-2210517, the compression springs located between the wedges and recessed abutments, which latter are formed of plastics material and are secured in place, following insertion after the wedges and springs, by squeezing in pairs of wings on the body at the ends of the channels remote from the bores. The use of plastics material for the abutments is not detrimental to the fire-rating of the connector because once the wedges have become secured in gripping engagement with wires the abutments and springs are redundant. However, while the body of the connector, which if made of a suitable high temperature resistant material, such as stainless steel, has an adequate fire-rating, the wedges or rollers, which are made of sintered carbon steel, do not ensure an adequate fire-rating because, even though their ribs soften and tend to lose their grip on the wires when subjected to high temperature, the combination of stresses imposed by the wedges or rollers under increasing temperatures causes the wires to fail long before the required fire-rating can be achieved.

Therefore, in accordance with the present invention, in a wire connector of the type having within a metal body twin bores at least one of which is associated with wedging means preventing withdrawal of a wire or suspension strand in the opposite direction to insertion, the wedging means is made of ceramic material, an example of which is known as Sintox-FA and will resist the high temperatures required to comply with fire regulations.

The wedging means may be a roller or rollers but is preferably a wedge or wedges, but in either case the surprising result is that the wires do not fail until the fire-rating has been exceeded, because ceramic wedges or rollers (a) do not expand (or expansion is negligible compared with that of metal wedges or rollers) and (b) shield the wires from heat for a longer period that do metal wedges or rollers, particularly at the junction of the ribs and wires, whereby expansion of the wires is lessened with consequent reduction in stresses in the wires resulting in a much greater delay to failure of the wires.

Additionally, whereas with metal wedges welding takes place at relatively low temperatures at the interface of the wedges and the body, thus preventing movement of the wedges to compensate for thinning of the wires, with ceramic wedges no welding whatsoever can occur, thus maintaining the functional capability of the connector in the event that fire causing the situation is extinguished before failure of the wires occurs.

The use of ceramic wedging means also has advantages in normal use of the connector.

Sintered carbon steel wedges or rollers are restricted to a maximum hardness range of 48 to 58 HRc and attempts to move the range upwards by means of special alloy steels has produced insignificant gains, whereas the use of ceramic material will raise the hardness range to make the wedges suitable for use with high tensile wires now available.

The ribs of ceramic wedges or rollers will have the wear resistance required to withstand the effects of abrasion by pulling long lengths of wire through the connector during installation.

Ceramic wedging means will also be ideal for use in harsh environments due to the inert properties of this material, which will be an advantage in two ways, namely; there will be no electrolytic effect between the wedging means and wires so that corrosion that may otherwise occur is eliminated; and, because the ceramic material will not produce corrosion products, which cause the wedging means to become locked in place, and so malfunction during re-tensioning of the wires will be avoided.

Although the use of plastics material for the abutments is not detrimental to the fire-rating, for the reason stated above, there are hazards from melting or burning plastics material such as toxic fumes and dripping molten plastics causing damage or further fire. Therefore, the abutments are preferably made of metal, more particularly stainless steel, also used for the springs, as well as for the body, which can be advantageously formed with great precision (and, therefore, least waste or excess weight) by investment casting or by metal injection moulding. The abutments may each be formed by bending a metal strip into a U-shape with a flat base, inserted into guide grooves in the sides of the outer ends of the channels, and secured by squeezing in pairs of wings on the body at the ends of the channels remote from the bores; the arms of the U's being directed towards the respective wedges for positive location of the outer ends of the springs, and the preferred wedges being provided with integral projections to prevent the inner ends of the respective springs being dislodged from contact with the wedges, especially when the wedges are moved towards the abutments by inserted wire ends, as described in WO-A-9530844.

For use in applications where initial adjustment may be necessary, such as described in GB-A-2322435, the body is preferably provided with a hole from each end, each hole being adjacent the inlet end of the respective bore and generally parallel to that bore, to allow insertion of a rod-like tool for pushing the respective wedging means out of contact with the inserted wire, such as is described in WO-A-9530844.

An embodiment of the invention will now be described, by way of example only, with reference to the accompanying drawings, in which:

FIG. 1 is a side elevation, twice actual size, of a preferred embodiment of wire connector in accordance with the invention;

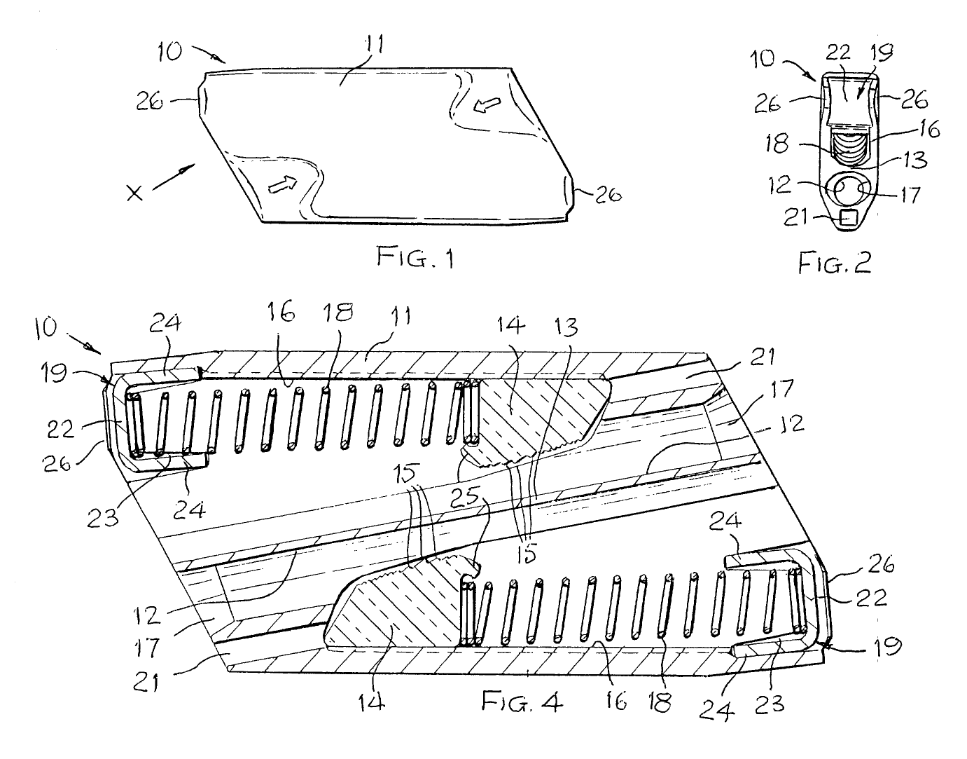

FIG. 2 is a view in the direction of the arrow X in FIG. 1;

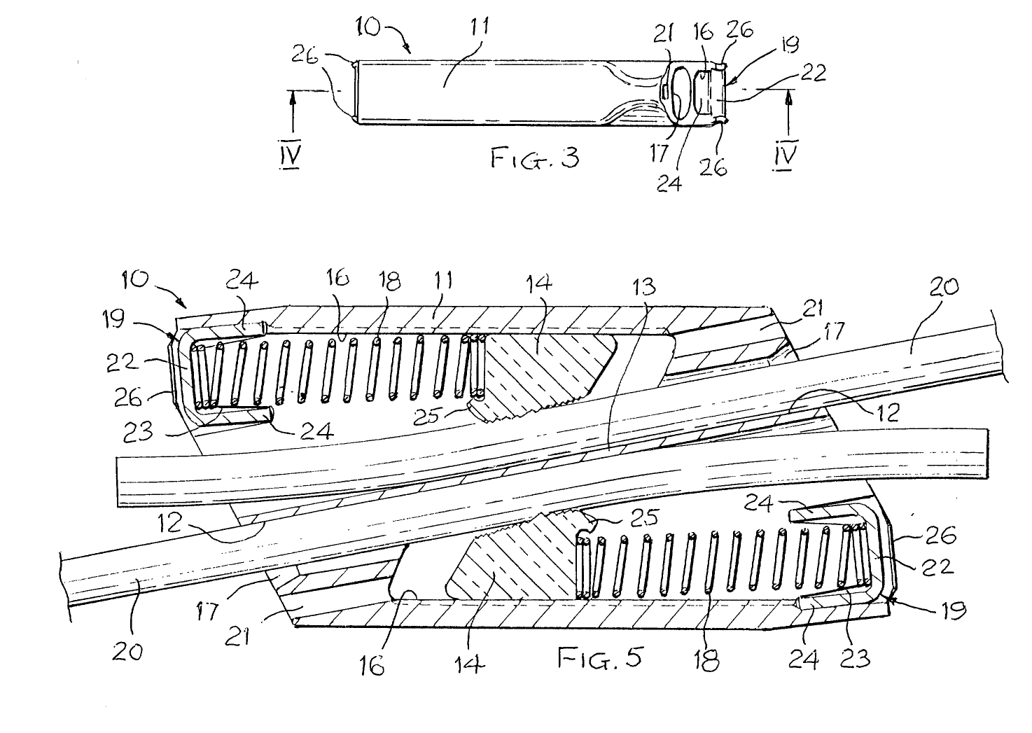

FIG. 3 is a view from above in FIG. 1;

FIG. 4 is a longitudinal section, four times actual size, taken from the live IV-IV in FIG. 3; and

FIG. 5 corresponds to FIG. 4 but shows wires inserted into the connector and secured by wedges in the connector body.

The fire-rated wire connector 10 shown in the drawings has a metal body 11 formed of stainless steel with great precision by investment casting or by metal injection moulding, having twin bores 12 in close lengthwise relationship separated by an intervening thin wall 13, and ceramic wedges 14 (with ribs 15) guided within channels 16 which converge towards the inlet ends 17 of the respective bores, compression springs 18 of stainless steel being provided between abutments 19 of stainless steel and the wedges for urging the latter into gripping engagement with inserted wires 20 (or wire cables) as shown in FIG. 5.

The body 11 is also provided with a hole 21 from each end, each hole being adjacent the inlet end 17 of the respective bore 12 and generally parallel to that bore, to allow insertion of a rod-like tool (not shown, but such as is described and illustrated in WO-A-9530844) for pushing the respective wedge 14 out of contact with the respective wire 20, for use in applications where initial adjustment may be necessary, such as described in GB-A-2322435.

The abutments 19 are each formed by bending a stainless steel strip into a U-shape with a flat base 22 as shown, inserted into guide grooves 23 in the sides of the outer ends of the channels 16, the arms 24 of the U's being directed towards the respective wedges 14 for positive location of the outer ends of the springs 18, the wedges being provided with integral projections 25 to prevent the inner ends of the respective springs being dislodged from contact with the wedges, especially when the wedges are moved towards the abutments by inserted wire ends. The abutments 19 are secured by squeezing in pairs of wings 26 on the body 11 at the ends of the channels 16 remote from the bores 12.

1. A fire-rated wire connector of the type having within a metal body twin bores at least one of which is associated with wedging means preventing withdrawal of a wire or suspension strand in the opposite direction to insertion, wherein the wedging means is made of ceramic material.

2. A wire connector as in claim 1, wherein ceramic wedging means are associated with both bores.

3. A wire connector as in claim 2, wherein the wedging means are guided within channels which converge towards the inlet ends of respective bores, with compression springs between abutments and the wedging means to urge the latter towards an intervening thin wall between the bores.

4. A wire connector as in claim 3, wherein the wedging means are rollers with ribs for gripping engagement with wires inserted in the bores.

5. A wire connector as in claim 3, wherein the wedging means are wedges with ribs for gripping engagement with wires inserted in the bores.

6. A wire connector as in claim 3, wherein the abutments are each formed by bending a metal strip into a U-shape with a flat base, inserted into guide grooves in the sides of the outer ends of the channels, and secured by squeezing in pairs of wings on the body at the ends of the channels remote from the bores; the arms of the U's being directed towards the respective wedges for positive location of the outer ends of the springs, and the wedges being provided with integral projections to prevent the inner ends of the respective springs being dislodged from contact with the wedges.

7. A wire connector as in claim 3, wherein the abutments are formed of stainless steel.

8. A wire connector as in claim 1, wherein the body is formed of stainless steel.

9. A wire connector as claimed in claim 8, wherein the body is formed by investment casting.

10. A wire connector as in claim 8, wherein the body is formed by metal injection moulding.
